(19) United States
(12) Patent Application Publication
(10) Pub. No.: US 2026/0192695 A1
(43) Pub. Date: Jul. 9, 2026

(54) METHOD FOR OPERATING A CHARGING DEVICE FOR A VEHICLE AND CONTROL UNIT FOR A CHARGING DEVICE

(71) Applicant: Robert Bosch GmbH, Stuttgart (DE)

(72) Inventors: Andreas Schoenknecht, Renningen (DE); Christoph Van Booven, Bietigheim-Bissingen (DE); Thomas Kopp, Ostfildern (DE)

(21) Appl. No.: 19/133,301

(22) PCT Filed: Oct. 5, 2023
(86) PCT No.: PCT/EP2023/077529

§ 371 Date: May 28, 2025

(30) Foreign Application Priority Data
Nov. 28, 2022 (DE) 10 2022 212 671.8

(51) Int. Cl. B60L 53/62; B60L 53/10; B60L 53/22; H02M 1/00; H02M 1/32; H02M 3/335

(52) U.S. Cl. CPC B60L 53/62; B60L 53/11; B60L 53/22; H02M 1/0006; H02M 1/007; H02M 1/322; H02M 3/33573; H02M 3/33584

(57) ABSTRACT

Method (800) for operating a charging device for a vehicle, wherein the charging device (500) comprises an input circuit, an intermediate capacitor (CZ), a bi-directional DC-DC converter, a circuit unit (402) and a control unit (452), wherein the method (800) is designed to at least partially reduce or discharge an electrical charge applied to the DC-DC converter (450) on the output side, comprising the steps of: receiving (810) a signal for discharging the electrical charge applied to the DC-DC converter (450) on the output side, supplying (820) the control unit (452) with power via the circuit unit (402), controlling (830) the DC-DC converter (450) by means of the control unit (452) in a discharge mode, such that the charge applied to the DC-DC converter (450) on the output side is transported in the direction of the intermediate connection (300) and the intermediate capacitor (CZ) is charged.

### BACKGROUND

The invention relates to a method for operating a charging device for a vehicle and a control unit for a charging device. The invention also relates to a charging device with a control unit, a drive train with a control unit or a charging device, a vehicle with a drive train, and a computer program and a computer-readable storage medium.

Method for operating a charging device, for example in vehicles with an electric drive in an electric drive in an electric vehicle or a hybrid vehicle, are used to recharge batteries, preferably accumulators or traction batteries, from an electrical energy source, preferably an external alternating voltage source or the public alternating voltage power supply. The charging device converts sinusoidal alternating current from the external power source into direct current.

Preferably, charging devices have two-stage power electronics. A first stage, the so-called power-factor-correction stage, the PFC stage, converts the sinusoidal input voltage from the alternating voltage power grid into a direct voltage. A second stage consists of a direct voltage converter or DC/DC converter that ensures galvanic isolation via a transformer and adjusts the voltage levels. Preferably, the output voltage and/or the output current for charging the battery is adjusted by means of an electric circuit and a controller. An intermediate capacitor is arranged between the two stages, which buffers the power pulsation in the double frequency of the alternating voltage current of the power source. These topologies allow for the maintenance of a near sinusoidal input current on the power grid side to meet power grid-side standards, a galvanic isolation between the power grid and vehicle to meet safety requirements, and a constant direct voltage output current on the side of the battery to minimize the load on the battery during charging.

In an electric drive vehicle, the battery is further connected to an inverter to supply energy to the electric drive machine. A DC-DC converter is usually connected in parallel to the inverter to supply a low-voltage network, or an on-board power supply, of the vehicle to supply the control devices with energy. Not least to prevent electromagnetic interference, a consumer in a high-voltage system, such as an inverter, a DC/DC converter or a DC voltage converter, comprises capacitors between the high-voltage connections which filter out rapid changes in the high-voltage voltage that occur during operation.

In the event of an accident or before carrying out repairs on the vehicle, the electrical charge in the capacitors of the vehicle's high-voltage or high-voltage system must be reliably discharged so that there is no risk of injury to persons if they touch or come into contact with cables or components of the high-voltage system. As known from publication EP 2 516 197 B1, corresponding discharge circuits are usually provided in a decentralized manner in individual components of the high-voltage system, e.g., in inverters. The discharge circuits comprise additional components for this purpose, which increase the required installation space and weight. There is therefore a need for methods that at least partially centralize such discharge circuits, replace them in part or in full, or accelerate the discharge of the high-voltage system.

### SUMMARY

The present invention provides a method for operating a charging device for a vehicle. The charging device comprises, on the input side, an input terminal unit for connecting a single-phase or multiphase alternating voltage with n phases, where n is greater than or equal to 1, and an input circuit connected thereto for supplying a direct voltage to at least a bipolar intermediate connection. Such an input circuit comprises a rectifier circuit for converting the input-side alternating voltage into an output-side direct voltage. Preferably, the input circuit also comprises a PFC stage. A preferred topology for such an input circuit is a 3L TNPC, a Vienna rectifier or a (totem pole) PFC circuit. At least one intermediate capacitor is connected between the positive intermediate connection and the negative intermediate connection. A bi-directional DC-DC converter is connected to the intermediate connection on the input side. The bi-directional DC-DC converter is configured to convert the DC voltage applied to the intermediate connection into a charging voltage during charging mode and to supply it to a high-voltage system connectable to the output side of the DC-DC converter, preferably to a connectable battery. The high-voltage system, or a consumer connected to the high-voltage system, comprises at least one high-voltage capacitor which is connected between the potentials of the connectable high-voltage system. A circuit unit for generating an internal supply voltage for supplying a control unit for the charging device is connected or switched on the output side of the DC-DC converter. The circuit unit is preferably configured to supply the control unit from the connectable high-voltage system. The circuit unit is preferably configured to supply the control unit from the connectable high-voltage system in a discharge mode. The internal supply voltage is preferably an operating voltage for the control unit. The internal supply voltage preferably corresponds to a vehicle's on-board voltage and is, for example, 5.12, 24, or 48 volts. The internal supply voltage is preferably used to provide redundancy for an external supply voltage that is intended to supply the control devices in a vehicle. The control unit is configured to control the bi-directional DC-DC converter. Preferably, the control comprises the regulation of the bi-directional DC-DC converter, the control of the power switches of the DC-DC converter and/or the performance of diagnostics and diagnostic procedures of the DC-DC converter. The method is configured to at least partially reduce an electrical charge applied to the DC-DC converter on the output side during a discharge operation or, preferably, to discharge capacitances present in the connectable high-voltage system. Preferably, the applied electrical charge is stored in at least one capacitance, in the high-voltage capacitor, in the connectable high-voltage system or in at least one capacitance of a component of the connectable high-voltage system. The method comprises the steps of: receiving a signal or error signal for discharging the electrical charge present on the output side of the DC-DC converter. Preferably, this signal is determined within the charging device or by an external control device of the vehicle and received by the charging device, preferably the control unit. Preferably, this signal is determined, generated, and sent depending on a malfunction, a short circuit, an insulation fault, a diagnosis, the performance of a repair, the vehicle being turned off or parked, or the detection that a plug, preferably a signal plug, is not connected to the charging device. Further steps are: supplying the control unit via or by means of the circuit unit. controlling the DC-DC converter by means of the control unit in the discharge mode such that the charge applied on the output side is transported in the direction of the intermediate connection and the intermediate capacitor is charged. Similarly, the energy from the high-voltage system is used to generate the internal supply voltage by means of the circuit unit for the control unit in order to discharge the capacitors in the high-voltage system.

An advantage is provided by a method which enables reliable discharging of the capacitances or capacitors of a high-voltage system connected to the charging device. For this purpose, in the discharge mode, the charge applied on the output side is transferred to the input side by reverse operation of the bi-directional DC-DC converter of the charging device, thereby charging the intermediate capacitor.

An external energy source is preferably a single-phase or multiphase, preferably three-phase, alternating voltage network, preferably the public low-voltage network, preferably for supplying households, industry, and/or infrastructure. Preferably, in a North American region or Japanese region, this is a 120 or 240 volt single-phase alternating voltage network. Preferably, in a Chinese or European region, this is a three phase alternating voltage power system of about 230 Volts. For charging mode of the charging device, the charging device is preferably connected to a corresponding alternating voltage power supply via the n-phase input terminal unit or connected to the corresponding alternating voltage. Preferably, the n-phase input terminal unit comprises a neutral terminal for connecting a neutral conductor of the alternating voltage power system to be connected. Preferably, a battery to be charged is an accumulator or a traction battery by means of which energy is supplied to an electric drive train of a vehicle. A rectification circuit is preferably a rectifier for converting the alternating voltage current into a direct voltage current. A high side switch or a low side switch of a semiconductor bridge is preferably a power semiconductor switch, preferably comprising an intrinsic or extrinsic diode, preferably an IGBT or MOSFET, preferably based on Si, SiC or GaN technology. Preferably, the expression connecting, for example, a center pickup to a connecting line, means contacting or connecting the components by means of an electrically conductive line or a galvanic connection. The expression blocking, preventing, decoupling or preventing a current flow means disconnecting an electrically conductive line or connection. Preferably, the expression “switched” is used synonymously with “electrically connected,” wherein “switchably connected” means that an electrical connection can be established or disconnected, preferably by means of a switch or switching element. Preferably, the expression arranged is used to define the position of an electrical component, preferably a switch or switching element, within the circuit topology, comprising an electrical connection to the adjacent electrical components.

In one embodiment, the method comprises the further steps: determining a first measured value. controlling the DC-DC converter by means of the control unit in the discharge mode such that the charge applied to the DC-DC converter on the output side is transported in the direction of the intermediate connection and the intermediate capacitor is charged until the determined first measured value corresponds to a first predeterminable abort criterion. Preferably, the first abort criterion is selected such that such that termination occurs when a charge transfer from the output side of the DC-DC converter to the input side is detected. For this purpose, it is possible, for example, to determine a first measured value which characterizes a voltage, preferably reduced, applied to the DC-DC converter on the output side. If the first measured value corresponds to a predeterminable first threshold value which characterizes a predeterminable voltage value present on the output side of the DC-DC converter, the transport of the charge in the direction of the intermediate capacitor is interrupted. Alternatively, a current flow or a transferred amount of energy can be used as abort criteria, so that measured values are determined which characterize a current flow through the DC-DC converter or a time period.

In discharge mode, the DC-DC converter is controlled by the control unit such that the charge applied to the DC-DC converter on the output side in the high-voltage system, preferably from the high-voltage capacitor, is transported in the direction of the intermediate connection and the intermediate capacitor is charged. For this purpose, the control unit receives or determines a signal, preferably an error signal, whereupon the control unit discharges the electrical charge applied to the DC-DC converter on the output side by means of the discharge mode. Preferably, the charging device comprises a first measuring device which is configured to determine a first measured value. This could be a measuring device for directly determining an electrical quantity (current, voltage) on the output side of the DC-DC converter. Alternatively, one or more measuring devices could be used to determine one or more parameters (current, voltage, time duration) on the input and/or output side of the DC-DC converter and by means of an adapted calculation, an electrical parameter to be determined, preferably the voltage applied to the DC-DC converter on the output side or the amount of energy transferred, can be determined or characterized. Similarly, a corresponding first measured value or the voltage value can be received by the control unit, preferably by means of a bus system from a component in the high-voltage system. The discharge mode is carried out by the control unit until the first abort criterion is met. The first abort criterion is preferably selected so that there is no danger to persons if the live components are touched or so that the charge in the high-voltage system is reduced. The first abort criterion is preferably selected so that a value derived from the relevant international standards for high-voltage safety is guaranteed in the event of an abort.

Advantageously, a method is provided which combines discharging the capacitors of a high-voltage system connected to the charging device with a measuring device which enables reliable discharging and qualitative detection of the discharging of the high-voltage system.

In one embodiment, the method comprises the further steps: determining a second measured value. controlling the DC-DC converter by means of the control unit such that the charge applied in the intermediate capacitor is transported in the direction of the output side of the DC-DC converter and the at least one high-voltage capacitor of the connectable high-voltage system is charged. This is done until the second measured value corresponds to a second abort criterion. Preferably, the second abort criterion is selected so that an abort occurs when a charge transfer from the intermediate capacitor to the output side of the DC-DC converter is detected. For this purpose, it is possible, for example, to determine a second measured value which characterizes a voltage, preferably reduced, present on the input side of the DC-DC converter, at the intermediate connection or at the intermediate capacitor. If the second measured value corresponds to a predetermined second threshold value which characterizes a predetermined voltage value applied to the DC-DC converter on the input side, the transport of the charge in the direction of the output side of the DC-DC converter is interrupted. Alternatively, a current flow or a transferred amount of energy can be used as abort criteria, so that measured values are determined which characterize a current flow through the DC-DC converter or a time duration.

In discharge mode, the DC-DC converter is further controlled by means of the control unit such that the charge is transported from the intermediate capacitor to the output side of the DC-DC converter and any capacitance present in the connected high-voltage system, preferably the high-voltage capacitor, is recharged. The transport of the charge through the DC-DC converter is accompanied by losses in the DC-DC converter, so that the amount of charge to be transferred decreases. Preferably, the charging device comprises a second measuring device which is configured to determine a second measured value. This could be a measuring device for directly determining an electrical quantity (current, voltage) at the intermediate connection. Alternatively, one or more measuring devices could be used to determine one or more parameters (current, voltage, time duration) on the input and/or output side of the DC-DC converter and by means of an adapted calculation, an electrical parameter to be determined, preferably the voltage applied to the DC-DC converter on the input side at the intermediate connection or the amount of energy transferred, is determined or characterized. Similarly, a corresponding second measured value or the voltage value can be received by the control unit, preferably by means of a bus system from a component in the high-voltage system. The transport of the load and the associated control by means of the control unit is carried out until the second abort criterion is fulfilled. The second abort criterion is preferably selected such that with each repetition of the transport of the load in the direction of the output side of the DC-DC converter, the total load within the vehicle decreases.

Advantageously, a method is provided which enables and improves the discharging of the capacitances or capacitors of a high-voltage system connected to the charging device by means of the losses during operation of the DC-DC converter.

In another embodiment, the steps of the method described above are repeated sequentially until a third measured value corresponds to a third abort criterion. The third abort criterion is preferably selected such that an abort occurs when touching the live components does not pose a danger to persons. For this purpose, a third measured value is determined analogously to the first measured value and evaluated as a function of the third abort criterion.

The steps of discharging the high-voltage system and feeding the charge back into the high-voltage system are repeated until, due to the losses of the DC-DC converter, the entire electrical charge within the high-voltage system, preferably of the vehicle, is discharged to such an extent that the voltage at the live components is so low that there is no danger to persons and thus the third abort criterion is fulfilled.

Advantageously, a method is provided with a third abort criterion which ensures that the connected high-voltage system is discharged and that there is no danger to persons.

In one embodiment, the method comprises the further step of discharging the intermediate capacitor by means of a discharge circuit. Preferably, the intermediate capacitor is discharged by connecting parasitic resistors or a discharge resistor to it.

An advantage is provided by a method that enables the capacitance or capacitors of a high-voltage system connected to the charging device to be discharged centrally. To this end, the charge is first transferred from the high-voltage system to the intermediate capacitor, which is discharged by means of a discharge circuit. Preferably, this discharging of the intermediate capacitor can also take place in parallel with the steps for discharging the high-voltage system and/or feeding the charge back into the high-voltage system, thereby advantageously accelerating the method. The discharge methods presented can preferably be combined with further discharge methods, preferably with current pulses through power semiconductors or by shifting charge from the high-voltage system into storage devices that can be galvanically isolated from the high-voltage system, thereby ruling out any danger to persons.

The invention also relates to a control unit for a charging device which is configured to carry out the method described. The control unit is preferably a charge control unit. Advantageously, a control unit is provided which carries out the described method. For this purpose, the DC-DC converter is controlled such that the capacitances or capacitors of the high-voltage system connected to the charging device are discharged.

The invention also relates to a charging device with a control unit as described. The charging device comprises, on the input side, an input terminal unit for connecting a single-phase or multiphase alternating voltage with n phases, wherein n is greater than or equal to 1, and an input circuit connected thereto for supplying a direct voltage to at least a bipolar intermediate connection. At least one intermediate capacitor is connected between the positive intermediate connection and the negative intermediate connection. A bi-directional DC-DC converter is connected to the intermediate connection on the input side and is configured in a charging mode, converting the DC voltage applied at the intermediate connection into a charging voltage and supplying it to a high-voltage system connectable on the output side of the DC-DC converter, preferably to a connectable battery. The high-voltage system comprises at least one high-voltage capacitor which is connected between the potentials of the connectable high-voltage system. The charging device comprises a circuit unit for generating an internal supply voltage for supplying the control unit for the charging device.

Advantageously, a charging device is provided which is configured by means of the control unit and the bi-directional DC-DC converter to discharge the capacitances or capacitors of the high-voltage system connected to the charging device.

In one embodiment, the circuit unit is configured to supply the control unit from the connectable high-voltage system. Preferably, the circuit unit is connected to the output side of the DC-DC converter to generate an internal supply voltage for the control unit for the charging device.

Advantageously, a circuit topology is provided which enables the control unit to be supplied from the connectable high-voltage system to be discharged.

In one embodiment, the circuit unit for generating the internal supply voltage for the control unit for the charging device is a second DC-DC converter for converting the energy from the high-voltage system into the internal supply voltage for the control unit.

Advantageously, a possibility is provided for designing a circuit unit for supplying the control unit for the charging device from the connectable high-voltage system.

In one embodiment, the intermediate capacitor of the charging device comprises at least one electrolytic capacitor. Electrolytic capacitors are particularly suitable for this application because they are high-voltage and cycle-resistant.

A capacitor type that is particularly preferred for this application is provided.

In one embodiment, the bi-directional DC-DC converter comprises at least one LLC, CLLC, or dual active bridge circuit. A circuit topology of the bi-directional DC-DC converter with or without galvanic isolation can also be used depending on the boundary conditions of the application.

Suitable circuit types for use in a bi-directional DC-DC converter are provided.

Furthermore, the invention relates to a drive train of a vehicle with a control unit or a charging device as described above, wherein the drive train comprises in particular a traction battery, an inverter and/or an electric machine.

Advantageously, a drive train of an electric vehicle is provided with a control unit or a charging device which is configured to discharge the capacitances or capacitors of the high-voltage system connected to the charging device during a discharge mode by means of the charging device.

The invention further relates to a vehicle having a drive train, as described above.

Advantageously, a vehicle with an electrified drive train with a simplified discharge process is provided.

The invention further relates to a computer program comprising commands which, when the program is executed by the control unit, cause it to carry out the method described.

The invention also relates to a computer-readable storage medium comprising commands which, when executed by the control unit, cause it to carry out the method described.

It is understood that the features, characteristics, and advantages of the method apply accordingly to the control unit, the charging device or the drive train and the vehicle, and vice versa.

Further features and advantages of embodiments of the invention are apparent from the following description with reference to the accompanying drawings.

### BRIEF DESCRIPTION OF THE DRAWINGS

The invention will be explained in further detail hereinafter with reference to the drawings:

FIG. 1 a schematic illustration of an embodiment of a circuit topology for a charging device with a control unit.

FIG. 2 a schematic illustration of a vehicle comprising a drive train with a charging device,

FIG. 3 a schematic illustration of a flowchart for a method for operating a charging device.

### DETAILED DESCRIPTION

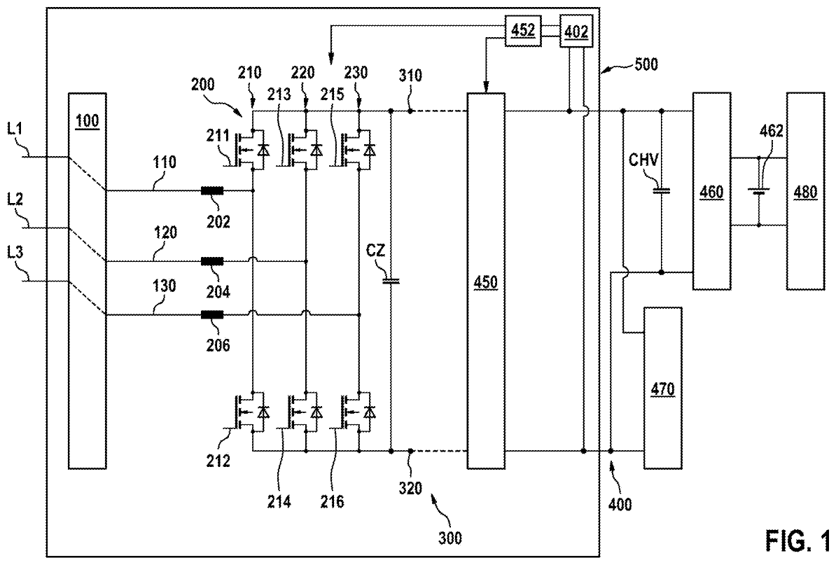

FIG. 1 shows a charging device 500, preferably for a vehicle. The charging device 500 comprises, on the input side, an input terminal unit 100 for connecting a three-phase AC voltage shown as an example, an input circuit 200 for supplying a DC voltage to a bipolar intermediate connection 300. An intermediate capacitor CZ is connected between the positive intermediate connection 310 and the negative intermediate connection 320. Furthermore, a bi-directional DC-DC converter 450 is connected to the intermediate connection 300. The DC voltage at the intermediate connection 300, which is applied to the DC-DC converter 450 on the input side, is converted into a charging voltage in a charging mode and made available on the output side of the DC-DC converter 450 to supply a high-voltage system 400 connectable on the output side to the DC-DC converter 450 and/or to charge a battery 470 connectable on the output side of the DC-DC converter 450, preferably a traction battery or high-voltage battery. The high-voltage system 400 comprises at least one high-voltage capacitor CHV, a capacitance in the high-voltage system 400. The high-voltage capacitor CHV is shown as an example for at least one of the capacitances of the components connected to the high-voltage system 400. Preferably, the high-voltage system 400 comprises several consumers. Preferably, a third DC-DC converter 460, preferably a step-down converter, is connected in parallel to the battery 470 to convert the charging voltage into a low voltage for charging a low-voltage battery 462 and for supplying a vehicle electrical system for supplying the control devices of a vehicle. The low-voltage battery 462, and preferably also further low-voltage loads 480, are connected to the vehicle's on-board power supply.

In the event of an accident or before carrying out repairs on the vehicle, the capacitors of the vehicle's 400 V high-voltage system or high-voltage system must be reliably discharged so that there is no risk of injury to persons in the event of contact with cables or components of the high-voltage system. According to the invention, the DC-DC converter 450 is operated by means of a control unit 452 in a discharge mode such that the charge present on the output side in the high-voltage system 400, preferably from the high-voltage capacitor CHV, is transported in the direction of the intermediate connection 300 and the intermediate capacitor CZ is charged. For this purpose, the control unit receives or determines a signal, preferably an error signal, whereupon the control unit 452 discharges the electrical charge applied to the DC-DC converter 450 on the output side by means of the discharge mode. Preferably, the charging device comprises a first measuring device (not shown in FIG. 1 for reasons of clarity), which is configured to determine a first measured value that characterizes the voltage applied to the DC-DC converter 450 at the output side. This could be a first measuring device for directly determining the voltage on the output side of the DC-DC converter. Alternatively, the voltage applied to the output side of the DC-DC converter 450 could be determined or characterized by means of one or more measuring devices for determining one or more electrical parameters (current, voltage) on the input and/or output side of the DC-DC converter and by means of an adapted calculation. Similarly, a corresponding first measured value or the voltage value can be transmitted to the control unit 452, preferably by means of a bus system from a component in the high-voltage system or vehicle electrical system. Preferably, the charging device comprises a second measuring device (not shown in FIG. 1 for reasons of clarity), which is configured to determine a second measured value that characterizes a voltage applied to the bipolar intermediate connection 300. This could be a second measuring device for directly determining the voltage at the bipolar intermediate connection 300. Alternatively, one or more measuring devices for determining one or more electrical parameters (current, voltage) on the input and/or output side of the charging device 500 and an adapted calculation could be used to determine or characterize the voltage applied to the bipolar intermediate connection 300. Similarly, a corresponding second measured value or the voltage value can be transmitted to the control unit 452, preferably by means of a bus system from a component in the high-voltage system or vehicle electrical system. The charging device 500 further comprises a circuit unit 402, preferably a second DC-DC converter, which is configured to generate a supply voltage for the control unit 452 for the charging device 500. Preferably, the circuit unit 402 is connected to the output side of the DC-DC converter 450, so that the circuit unit 402 can draw energy from the connectable high-voltage system 400 to be discharged in order to supply the control unit 452. This ensures a reliable supply to the circuit unit as long as a high-voltage system 400 to be discharged is connected to the charging device. The control unit 452 is configured to control the DC-DC converter 450 such that, in a first step, the charge is first transferred from the connectable high-voltage system 400 to the intermediate capacitor CZ and then, in a second step, back to the high-voltage capacitor CHV. When the two steps are carried out, the amount of stored charge in the high-voltage system 400 is reduced, since the transfer of the charge through the DC-DC converter 450 is sufficiently lossy. Preferably, the DC-DC converter 450 is controlled during at least one of the two steps in discharge mode such that the losses of the DC-DC converter 450 are greater than in charge mode. These two steps are repeated sequentially until the high-voltage capacitor CHV is discharged to such an extent that there is no danger to persons if they touch the live components. The first and second steps are each aborted if the corresponding abort criterion is met. The first and second abort criteria are adjusted each time the process is repeated so that a significant discharge of the system from the charging device and high-voltage system occurs when the first or second step is performed. The third abort criterion for the entire discharge process is specified such that there is no danger to persons if live components, preferably the high-voltage system, are touched.

An exemplary input circuit 200, an exemplary PFC stage of the charging device 500 comprises a first 210, a second 220 and a third 230 half-bridge. The first, second, and third half-bridges 210, 220, 230 each include a series connection having a high-side switch 211, 213, 215 and a low-side switch 212, 214, 216. In each case, a center pickup between the high-side switch and the low-side switch of a half-bridge can be connected via a first, second and third inductor 202, 204, 206 to a first, second and third input terminal L1, L2, L3 of the input terminal unit 100 via a first, second and third connecting line 110, 120, 130 in each case. Thus, the center pickup of the first half-bridge 210 can be connected via the first throttle 202 to the first input terminal L1 via the first connecting line 110. Thus, the center pickup of the second half-bridge 220 can be connected via the second throttle 204 to the second input terminal L2 via the second connecting line 120. Thus, the center pickup of the third half-bridge 230 can be connected via the third throttle 206 to the third input terminal L3 via the third connecting line 130. The half-bridges 210, 220, 230 are connected in parallel. Their ends are connected to the bipolar intermediate connection 300. The high-side switches are connected to a positive intermediate connection 310 and the low-side switches are connected to a negative intermediate connection 320.

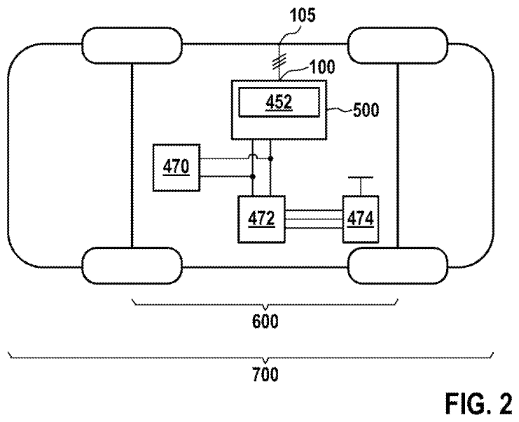

FIG. 2 shows a schematic illustration of a vehicle 700 with a drive train 600 and a charging device 500. The input terminal unit 100 of the charging device 500 is preferably connectable to an external energy source via an electrical connection via a charger connection 105. An external energy source is preferably connected to the charger connection 105 via a wall box. This connection is preferably used for charging mode. However, a feedback operation is also possible, in which energy from the battery 470 is fed back to the external energy source. The vehicle 700 is in this case shown (only by way of example) as comprising four wheels, wherein the invention can be used equally in any vehicle with any desired number of wheels on land, on water, and in the air. The exemplary drive train 600 comprises at least one charging device 500 with a control unit 452. Preferably, the charging device 500 comprises a circuit unit 402 (not shown in this figure) for generating a supply for the control unit 452. Furthermore, the drive train preferably comprises a battery 470, an inverter 472 and/or or an electric machine 474. Preferably, any further consumers, which preferably comprise further capacitances between the high-voltage connections, are connected to the high-voltage system 400 of the drive train 600. The charging device 500 is shown here within the vehicle merely as an example. The charging device can also be designed as a stand-alone charging device 500, preferably as a charging station or wall box, and arranged outside a vehicle.

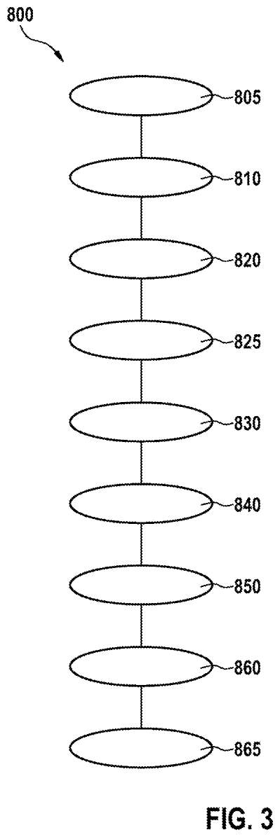

FIG. 3 shows a schematic flowchart for a method 800 for operating a charging device 500. The method 800 starts with step 805. In step 810, a signal is received for discharging the electrical charge applied to the DC-DC converter 450 on the output side. In step 820, the control unit 452 is supplied with electrical energy via the circuit unit 402. For this purpose, the circuit unit 402 is controlled accordingly, preferably corresponding circuit devices within the circuit unit 402 are closed and/or controlled. In step 825, a first measured value is determined, which preferably characterizes a voltage applied to the DC-DC converter 450 on the output side. In step 830, the DC-DC converter 450 is operated or controlled in a discharge mode such that the charge applied to the DC-DC converter 450 on the output side is transported in the direction of the intermediate connection 300 and the intermediate capacitor CZ is charged. Preferably, the charge applied to the DC-DC converter 450 on the output side is transported in the direction of the intermediate connection 300 until the determined first measured value corresponds to a first abort criterion, preferably a first predeterminable threshold value, which characterizes a falling below a predeterminable first voltage value present on the output side of the DC-DC converter 450. In step 840, a second measured value is preferably determined, which preferably characterizes a voltage applied to the bipolar intermediate connection 300. In step 850, the DC converter 450 is preferably controlled by means of the control unit 452 such that the charge present in the intermediate capacitor CZ is transported in the direction of the output side of the DC-DC converter 450 and the at least one high-voltage capacitor CHV of the connectable high-voltage system 400 is charged, preferably until the determined second measured value corresponds to a second abort criterion, preferably a second predeterminable threshold value, which characterizes a falling below a predeterminable second voltage value applied to the bipolar intermediate connection 300. Preferably, the steps for shifting the charge from the high-voltage system 400 to the intermediate capacitor CZ and from the intermediate capacitor CZ back to the high-voltage system 400 are repeated, preferably several times, until a determined third measured value corresponds to a third abort criterion, preferably a third predeterminable threshold value, which characterizes a falling below a third predetermined voltage value applied to the DC-DC converter 450 on the output side. Wherein, during the repetitions, step 830 preferably takes place as the last step, in which the DC-DC converter 450 is operated or controlled in a discharge mode such that the charge applied to the DC-DC converter 450 on the output side is transported in the direction of the intermediate connection 300 and the intermediate capacitor CZ is charged. Consequently, the steps are repeated one after the other until the high-voltage system 400 or the high-voltage capacitor CHV is discharged to such an extent that there is no danger to persons if the live components are touched. In step 860, the intermediate capacitor CZ is preferably discharged by means of a discharge circuit. This step 860 can also be performed in parallel with the other steps of the method. The method ends at step 865.

1. A method (800) for operating a charging device (500) for a vehicle,
wherein an input side of the charging device (500) comprises an input terminal unit (100) for connecting a single-phase or multiphase alternating voltage with n phases, wherein n is greater than or equal to 1, and an input circuit (200) connected thereto for supplying a DC voltage to a bipolar intermediate connection (300),
wherein an intermediate capacitor (CZ) is connected between the positive intermediate connection (310) and the negative intermediate connection (320),
wherein a bi-directional DC-DC converter (450) is connected on the input side to the intermediate connection (300), which is configured to convert the DC voltage applied to the intermediate connection (300) into a charging voltage in a charging mode and to supply it to a high-voltage system (400) connectable to the output side of the DC-DC converter (450),
wherein the high-voltage system (400) comprises at least one high-voltage capacitor (CHV) connected between the potentials of the connectable high-voltage system (400), and
wherein a circuit unit (402) is connected to the output side of the DC-DC converter (450) for generating an internal supply voltage for supplying a control unit (452) for the charging device (500),
wherein the method (800) is configured to at least partially reduce or discharge an electrical charge applied to the DC-DC converter (450) on the output side in a discharge mode.
said method comprising the following steps:
receiving (810) a signal for discharging the electrical charge applied to the DC-DC converter (450) on the output side,
supplying (820) the control unit (452) with power via the circuit unit (402), and
controlling (830) the DC-DC converter (450) by means of the control unit (452) in a discharge mode, such that the charge applied to the DC-DC converter 450 on the output side is transported in the direction of the intermediate connection (300) and the intermediate capacitor (CZ) is charged.

2. The method according to claim 1, further comprising the following steps:
determining (825) a first measured value, and
controlling (830) the DC-DC converter (450) by means of the control unit (452) in the discharge mode such that the charge applied to the DC-DC converter (450) on the output side is transported in the direction of the intermediate connection (300) and the intermediate capacitor (CZ) is charged until the determined first measured value corresponds to a first abort criterion.

3. The method according to claim 2, further comprising the following steps:
determining (840) a second measured value, and
controlling (850) the DC-DC converter (450) by means of the control unit (452) in such a way that the charge present in the intermediate capacitor (CZ) is transported in the direction of the output side of the DC-DC converter (450) and the at least one high-voltage capacitor (CHV) of the connectable high-voltage system (400) is charged until the determined second measured value corresponds to a second abort criterion.

4. The method according to claim 3, wherein
controlling (830) the DC-DC converter (450) by means of the control unit (452) in the discharge mode such that the charge applied to the DC-DC converter (450) on the output side is transported in the direction of the intermediate connection (300) and the intermediate capacitor (CZ) is charged until the determined first measured value corresponds to a first abort criterion, and
controlling (850) the DC-DC converter (450) by means of the control unit (452) in such a way that the charge present in the intermediate capacitor (CZ) is transported in the direction of the output side of the DC-DC converter (450) and the at least one high-voltage capacitor (CHV) of the connectable high-voltage system (400) is charged until the determined second measured value corresponds to a second abort criterion,
are repeated sequentially until a determined third measured value corresponds to a third abort criterion.

5. The method according to claim 1,
comprising the further step of:
discharging (860) the intermediate capacitor (CZ) by means of a discharge circuit.

6. A control unit (452) for a charging device (500);
wherein the charging device (500) includes
an input side having an input terminal unit (100) for connecting a single-phase or multiphase alternating voltage with n phases, wherein n is greater than or equal to 1, and an input circuit (200) connected thereto for supplying a DC voltage to a bipolar intermediate connection (300),
an intermediate capacitor (CZ) is connected between the positive intermediate connection (310) and the negative intermediate connection (320),
a bi-directional DC-DC converter (450) connected on the input side to the intermediate connection (300), which is configured to convert the DC voltage applied to the intermediate connection (300) into a charging voltage in a charging mode and to supply it to a high-voltage system (400) connectable to the output side of the DC-DC converter (450), wherein the high-voltage system (400) comprises at least one high-voltage capacitor (CHV) connected between the potentials of the connectable high-voltage system (400), and
a circuit unit (402) connected to the output side of the DC-DC converter (450) for generating an internal supply voltage for supplying a control unit (452) for the charging device (500),
wherein the control unit (452) is configured to
receive (810) a signal for discharging the electrical charge applied to the DC-DC converter (450) on the output side,
supply (820) the control unit (452) with power via the circuit unit (402), and
control (830) the DC-DC converter (450) by means of the control unit (452) in a discharge mode, such that the charge applied to the DC-DC converter 450 on the output side is transported in the direction of the intermediate connection (300) and the intermediate capacitor (CZ) is charged.

7. A charging device with a control unit (452) according to claim 6,
wherein the input side of the charging device (500) comprises an input terminal unit (100) for connecting a single-phase or multiphase alternating voltage with n phases, wherein n is greater than or equal to 1, and an input circuit (200) connected thereto for supplying a DC voltage to a bipolar intermediate connection (300),
wherein an intermediate capacitor (CZ) is connected between the positive intermediate connection (310) and the negative intermediate connection (320),
wherein a bi-directional DC-DC converter (450) is connected on the input side to the intermediate connection (300), and is configured to convert the DC voltage applied to the intermediate connection (300) into a charging voltage in a charging mode and to supply it to a high-voltage system (400) connectable to the output side of the DC-DC converter (450),
wherein the high-voltage system (400) comprises at least one high-voltage capacitor (CHV) connected between the potentials of the connectable high-voltage system (400),
and wherein the charging device (500) comprises a circuit unit (402) for generating an internal supply voltage for supplying the control unit (452) for the charging device (500).

8. The charging device (500) according to claim 7, wherein the circuit unit (402) for generating the internal supply voltage for the control unit (452) for the charging device (500) is connected to the output side of the DC-DC converter (450).

9. The charging device (500) according to claim 7, wherein the circuit unit (402) for generating the internal supply voltage for the control unit (452) for the charging device (500) comprises a second DC-DC converter, for converting the energy from the high-voltage system (400) into the internal supply voltage for the control unit (452).

10. The charging device according to claim 7,
wherein the intermediate capacitor (CZ) comprises at least one electrolytic capacitor.

11. The charging device according to claim 7,
wherein the bi-directional DC-DC converter (450) comprises at least one LLC, CLLC, or dual active bridge circuit.

12. A drive train (600) of a vehicle (700) with a control unit (452) according to claim 6 or a charging device (500) according to claim 7.

13. A vehicle (700) having a drive train (600) according to claim 12.

14. (canceled)

15. A non-transitory, computer-readable storage medium comprising instructions which, when executed by a control unit (452) cause the control unit to control a charging device (500) that includes
an input side having an input terminal unit (100) for connecting a single-phase or multiphase alternating voltage with n phases, wherein n is greater than or equal to 1, and an input circuit (200) connected thereto for supplying a DC voltage to a bipolar intermediate connection (300),
an intermediate capacitor (CZ) is connected between the positive intermediate connection (310) and the negative intermediate connection (320),
a bi-directional DC-DC converter (450) connected on the input side to the intermediate connection (300), which is configured to convert the DC voltage applied to the intermediate connection (300) into a charging voltage in a charging mode and to supply it to a high-voltage system (400) connectable to the output side of the DC-DC converter (450), wherein the high-voltage system (400) comprises at least one high-voltage capacitor (CHV) connected between the potentials of the connectable high-voltage system (400), and
a circuit unit (402) connected to the output side of the DC-DC converter (450) for generating an internal supply voltage for supplying a control unit (452) for the charging device (500),
by
receiving (810) a signal for discharging the electrical charge applied to the DC-DC converter (450) on the output side,
supplying (820) the control unit (452) with power via the circuit unit (402), and
controlling (830) the DC-DC converter (450) by means of the control unit (452) in a discharge mode, such that the charge applied to the DC-DC converter 450 on the output side is transported in the direction of the intermediate connection (300) and the intermediate capacitor (CZ) is charged.
